(19) United States
(12) Patent Application Publication
(10) Pub. No.: US 2012/0203641 A1
(43) Pub. Date: Aug. 9, 2012

(54) Advertising conjoined information

(76) Inventor: Tristan Joseph Palijan, Princeton (CA)

(21) Appl. No.: 13/021,703

(22) Filed: Feb. 4, 2011

(51) Int. Cl. G06Q 30/00

(52) U.S. Cl. 705/14.69

(57) ABSTRACT

The present invention is a method of advertising, combining information provided by the advertiser with database statistics and/or other relevant information provided by the person applying the present invention. The conjoined information is put on display as a paid advertisement and when selected by a website visitor, he/she will conclude on the same website that the paid advertisement is displayed on.

### BACKGROUND OF THE INVENTION

1. Field of the Invention

The present invention relates to an advertising method using internet websites. It describes a method of advertising, combining information from several sources to be used as a paid advertisement. The paid advertisement is put on display and when selected by a website visitor, he/she will conclude on the same website that the paid advertisement is displayed on.

2. Description of the Related Art

The World Wide Web (web) displays hypertext documents (web pages) hosted on web servers that are connected to the Internet. Web pages are served from websites and can be viewed via programs such as web browsers using the Hypertext Transfer Protocol (HTTP). A web page may be displayed by inputting a Uniform Resource Locator (URL) into the web browser. An advertisement may be included on a web page and when a website visitor selects the advertisement, he/she will conclude on the advertised URL or web page.

Website advertising, in which advertisers can find relevant consumers by displaying text, image or SWF advertisements, is an extremely profitable industry. However, the primary goal of a website owner is to find visitors for the website and to keep them there. Traditional website advertising does not generally appeal to this view, considering that in most cases you are directing visitors away from the website in an effort to earn revenue.

### BRIEF SUMMARY OF THE INVENTION

An object of the present invention is to provide an advertising method that will give a website owner a way to earn advertising revenue and simultaneously keep the visitors (that select the advertisements) on the same website that the advertisements are displayed on.

Another object of the present invention is to provide an advertising method that will give the members of a website a way to advertise and promote their own profile web page, goods and services to the rest of the visitors on the same website.

Essentially, the present invention would be most effectively used on social networking websites or similar websites where user generated information is the primary focus. However, it should be noted that the present invention may be utilized on various types of websites.

The present invention provides a method of advertising, combining information provided by the advertiser with database statistics and/or other relevant information provided by the person applying the present invention. The conjoined information is displayed as a paid advertisement and when selected by a website visitor, he/she will conclude on the same website that the paid advertisement is displayed on.

In some embodiments, the advertisement includes information about the advertiser such as the total number of items that the advertiser is selling.

In some embodiments, the advertisement is comprised of product specific information such as the name of an item and the current price.

### BRIEF DESCRIPTION OF THE FIGURES

FIG. 1 depicts information within an advertisement utilizing the present invention;

FIG. 2 shows an example of an advertisement illustrating the present invention;

FIG. 3 shows another example of an advertisement illustrating the present invention;

FIG. 4 is a flowchart illustrating the advertising operation of the present invention;

### DETAILED DESCRIPTION OF THE INVENTION

### Definitions

In order to provide a clear understanding of the specification and claims, the following definitions are given:

The term “conjoined information” refers to a combination of information that is the advertisement. It includes information provided by the advertiser, database statistics and/or other relevant information provided by the person applying the present invention.

The term “database statistic” refers to a numerical component included in the advertisement. This statistic may be a fickle component that changes whenever a notable occurrence takes place.

The term “paid advertisement” refers to selling the conjoined information to be used by advertisers as an advertisement. This also refers to displaying the conjoined information on a website or domain.

The term “selected” refers to the event of a website visitor clicking the advertisement or a component of the advertisement using a mouse or an input device. Afterwards the visitor concludes on the advertised URL or web page.

The term “conclude” refers to a website visitor ending on the advertised URL or web page after selecting the advertisement or a component of the advertisement.

The term “information associated with a visitor interacting with the paid advertisement” refers to a website visitor viewing or selecting the advertisement or a component of the advertisement. This information is electronically recorded and deposited to be viewed later.

### The Invention

In the following description, many details will be given to help provide a complete and thorough understanding of the present invention. It will be evident to those skilled in the art that certain components have not been discussed or illustrated for the purpose of staying within the boundaries and to keep from describing unnecessary details.

Furthermore, the following is provided to explain the present invention with reference to several embodiments that may be best utilized subject to the preference of the person applying the invention. Unless it is specifically stated, the embodiments discussed are not restricted or limited to a specific order and may take place simultaneously.

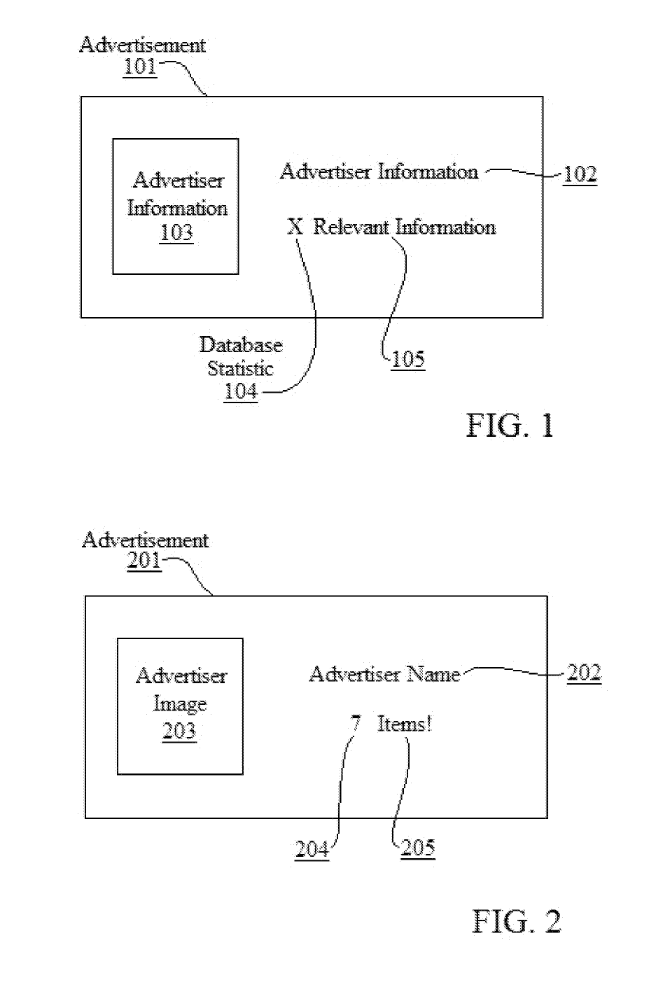

As shown in FIG. 1, advertisement 101 is comprised of several sources of information that collectively compose the advertisement. Advertiser information 102 and advertiser information 103 may be used to display multiple sorts of information provided by the advertiser. Database statistic 104 may be used to include a numerical component and when used in conjunction with relevant information 105, could provide added incentive for a visitor to select the advertisement.

The multiple sorts of information provided by the advertiser may comprise of different types of components that can be utilized in the advertisement such as text information and an image. This information may be an advertisers name and image, however it should be noted that the information provided may comprise of literally anything and is not limited to the embodiments discussed.

As shown in FIG. 2, advertisement 201 is a rough example that should help further clarify the kind of information that may be included in the present invention. In this example, advertiser information 202 is the name provided by the advertiser and advertiser information 203 consists of the image provided by the advertiser. Database statistic 204 shows numerically the total number of items that the advertiser is selling and relevant information 205 is included as a way to explain the database statistic 204 to the website visitor.

It should be noted that database statistic 204 may include any type of numerical information that can be utilized by the person applying the present invention. This type of information is not limited to the number of items that the advertiser is selling and may be used to display a wide range of numerical facts. The database statistic may be called upon directly from the advertisers' user database information.

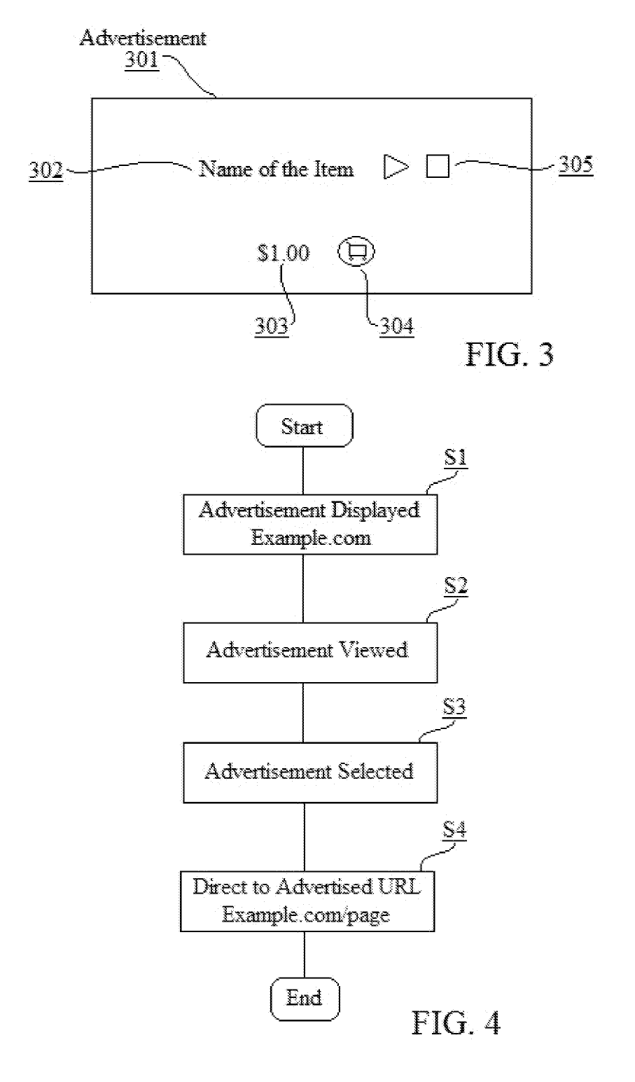

As shown in FIG. 3, advertisement 301 is another example of the type of information that may be included in the present invention. In this example, advertiser information 302 displays the name of the item and advertiser information 303 is the price of the item on display. Relevant information 304 is an add to cart image and relevant information 305 is a flash media player that will allow a website visitor to preview the item within the advertisement.

It should be noted that an advertisement may include hyperlinks to various advertised URLs. When a website visitor selects one of the hyperlinks, he/she will still conclude on the same website, domain, sub domain or fundamental URL that the advertisement is displayed on. For example, in FIG. 3, a website visitor may select advertiser information 302 and he/she will conclude on the advertisers' item web page. In another instance, a website visitor may select relevant information 304 and he/she will conclude on the cart checkout web page. It should also be noted that if necessary the entire area of an advertisement may be selectable, however this would limit the options contained within the advertisement.

The components and information displayed within the advertisement may comprise of anything that may enhance the experience or be considered useful to the website visitor and the advertiser. For example, FIG. 3 roughly illustrates a flash media player that is included in the advertisement. This may be utilized if an advertiser is promoting an item such as a musical work.

It will be apparent to those skilled in the art that the person applying the present invention would generally construct the core foundation of the advertisement. This may be achieved through various methods of computer web related program code such as PHP, HTML, Smarty templates or similar web-based coding languages that are in use by the website in question.

FIG. 4 is a flowchart depicting the advertising operation of the present invention. In step S1, the advertisement is put on display on the website example.com to be viewed. In step S2, the advertisement is viewed by the website visitor, afterwards in step S3 the website visitor selects the advertisement. In step S4, the website visitor concludes on the advertised URL or web page in this case example.com/page.

It should be noted that FIG. 4 does not contain information regarding the recording, depositing or the viewing of information associated with a visitor interacting with the advertisement. It would be unnecessary to include these components in the figure, as this part of the process would be considered obvious to those skilled in the art.

It should also be noted that the manner in which the advertiser information is provided and the manner of combining information from several sources, may be achieved in the most suitable way that is decided by the person applying the present invention. Generally, a web form will be utilized so that the information provided by the advertiser can be called from the websites' database. This will allow the advertiser information to be combined with the rest of the information that will be included in the advertisement.

An advertiser may be promoting a profile web page, this web page will comprise of the same domain or fundamental URL that the advertisement will be displayed on. In some cases, the advertisement may also conclude on and/or be displayed on a sub domain of the website. For example, the website in question may be utilizing several web servers as a way to conserve important resources such as disk space.

The advertisement may be displayed near or within relevant website content and if necessary it may be slightly altered (e.g. in color) to enhance and to stand out from the rest of the content around it. The advertisement may also be displayed on a section of the web page by itself, this decision is subject to the preference of the person applying the invention.

It should be understood that while the present invention has been described in relation to what would be regarded as the most practical embodiments, those skilled in the art will acknowledge that the invention can be practiced with modification and is not restricted to the above-disclosed embodiments. The present invention may be utilized in various arrangements and modifications that are considered to be within the spirit and scope of the appended claims.

What is claimed is:

1. A method of advertising, combining information provided by the advertiser with database statistics and/or other relevant information provided by the person applying the present invention, wherein the conjoined information is put on display as a paid advertisement, comprising, in no particular order, the steps of:
offering to sell or selling said conjoined information to be used as a paid advertisement; and
displaying said conjoined information as a paid advertisement on the same website, domain or sub domain that a visitor will conclude on after he/she has selected the paid advertisement.

2. The method according to claim 1 further comprising, in no particular order, the steps of:
electronically recording information associated with a visitor interacting with the paid advertisement, comprising date, time, advertised Uniform Resource Locator, source Uniform Resource Locator, Internet Protocol address and web browser name;
electronically depositing the information associated with a visitor interacting with the paid advertisement; and
viewing the information associated with a visitor interacting with the paid advertisement.

3. The method according to claim 1 further comprising, in no particular order, the steps of:
electronically recording information associated with a visitor interacting with the paid advertisement, comprising date, time, advertised Uniform Resource Locator, source Uniform Resource Locator, Internet Protocol address and web browser name;
electronically depositing the information associated with a visitor interacting with the paid advertisement; and
displaying to the advertiser the information associated with a visitor interacting with the paid advertisement.

4. The method according to claim 1, wherein said conjoined information directs to a different website or domain for the purpose of electronically recording, depositing or viewing information associated with a visitor interacting with the paid advertisement.

5. The method according to claim 1, wherein said conjoined information includes hyperlinks to various advertised Uniform Resource Locators.

6. The method according to claim 1, wherein said conjoined information includes at least one of the following: a trademark, a brand name, a company name, a business name, a media player and a copyrightable work.
